(19) United States
(12) Patent Application Publication
(10) Pub. No.: US 2012/0281311 A1
(43) Pub. Date: Nov. 8, 2012

(54) RAMP-UNLOADING SEEK CONTROL DEVICE FOR MAGNETIC DISK DRIVE

(75) Inventors: Yoshiyuki Ishihara, Kanagawa-ken (JP); Shinji Takakura, Kanagawa-ken (JP); Shigen Yasunaka, Kanagawa-ken (JP)

(73) Assignee: KABUSHIKI KAISHA TOSHIBA, Tokyo (JP)

(21) Appl. No.: 13/551,793

(22) Filed: Jul. 18, 2012

Related U.S. Application Data
(63) Continuation of application No. PCT/JP2010/050862, filed on Jan. 18, 2010.

(51) Int. Cl. G11B 5/55

(52) U.S. Cl. 360/78.06; G9B/5.182

(57) ABSTRACT

A ramp-unloading seek control device includes a voice coil motor, a detector, an instruction-current detector, a head-speed computing unit, and an identification structure. The identification structure estimates an error between a true resistance value and an estimated resistance value of the voice coil motor. The identification structure can minimize an estimated error defined as a difference between an estimated value ŷ(k) of the head speed and the head speed y(k), and employs \hat{b}₁ to calibrate the estimated error. \hat{b}₁ is determined by minimizing the estimated error. ŷ(k) and y(k) are defined by the equation (A):

ŷ(k)=−â₁y(k−1)+\hat{b}₀u(k−1)+\hat{b}₁u(k−2) (A).

y(k−1) denotes a head speed computed by the head-speed computing unit at the last sampling time. k denotes the present sampling time. u(k−1) and u(k−2) denote instruction currents at the last sampling time and the last but one sampling time, respectively. Unknown variables â₁, \hat{b}₀ are determined by minimizing the estimated error.

### CROSS REFERENCE TO RELATED APPLICATION

This is a Continuation Application of International Application No. PCT/JP2010/050862 filed on Jan. 18, 2010; all the entire contents of which are incorporated herein by reference.

### FIELD

Embodiments relate to a ramp-unloading seek control device for a magnetic disk drive.

### BACKGROUND

A magnetic head for recording/reproducing information and a recording medium should be prevented from contacting each other and being broken by an outer shock during operation in order to protect recorded information and its reliability in a magnetic disk system. Most of current magnetic disk systems have a ramp loading/unloading mechanism that evacuates the magnetic head from an operating area above a magnetic disk during power-off and idling without recording/reproducing.

The loading/unloading of a magnetic head requires loading seek control and unloading seek control. The loading seek control is to move the magnetic head from the ramp mechanism to an area above the disk. The unloading seek control is to move the magnetic head from the area above the disk to the ramp mechanism.

When the head is located on the ramp mechanism, the loading/unloading seek control cannot acquire information of the head position from a servo sector on the disk. For that reason, a speed control system is employed instead of the loading/unloading seek control. The speed control system computes a head speed from back electromotive force of a voice coil motor and causes the head speed to follow a targeted speed.

The back electromotive force generated in the voice coil motor is computed using the following formula including the resistance of the voice coil and the voltage across the voice coil:

(Back Electromotive Force)=(Voltage across Coil)−(Coil Resistance)×(Current through Coil).

When an estimate (e.g., designed value) is used for the coil resistance, the computed back electromotive force could be inaccurate, because the actual coil resistance varies with ambient temperature or batch to batch. Accordingly, a difference (error) between the estimate and the actual coil resistance is required to be calibrated. A procedure for the above calibration is executed as follows. A control current is prepared for the loading seek control so that a carriage of the head is pressed to the ramp mechanism in the dead-end direction thereof. Then a calibrated error of the coil resistance is computed using the control current, provided that the back electromotive force is zero. The calibration during the unloading seek is likely to press the carriage in the inner-circumference direction of the disk. Unfortunately, such calibration causes a contact risk of the head and the disk, or a noise problem.

There is known a calibration seek as a technique of the background art to solve the above problems. The calibration seek provides an interval to forcibly saturate a control current during acceleration or deceleration for the seek control, and then uses voltage across a coil during the interval and a head speed computed from position signals of servo sectors to estimate a coil resistance. Other method performs calibration on the basis of back electromotive force without the position signals whose errors are probably caused by the reading error of servo signals or noises.

### BRIEF DESCRIPTION OF THE DRAWINGS

Aspects of this disclosure will become apparent upon reading the following detailed description and upon reference to accompanying drawings. The description and the associated drawings are provided to illustrate embodiments of the invention and not limited to the scope of the invention.

FIG. 1 is a schematic view showing a configuration of a ramp-unloading seek control device for a magnetic disk drive in accordance with a first embodiment.

FIG. 2 is a diagram showing a ramp-unloading, seek control system in the ramp-unloading seek control device in accordance with the first embodiment.

FIG. 3 shows characteristics of a controlled object in a high frequency region.

FIG. 4 shows a dummy white signal employed as a targeted speed.

FIG. 5 is a graph showing a time history of a calibration gain \hat{θ}.

FIG. 6 is a graph showing a time history of a head speed.

FIG. 7 is a diagram showing a ramp-unloading seek control system in accordance with a second embodiment.

FIG. 8 shows frequency responses of a controlled object model.

FIG. 9 shows a vector locus of a computation for a transfer function using the controlled object model.

FIG. 10 is a graph showing responses of the head speed.

FIG. 11 is a graph showing estimated errors of the coil-resistance.

### DESCRIPTION

As will be described below, in accordance with an embodiment, a ramp-unloading seek control device is for a magnetic disk drive, and includes a voice coil motor, a detector, an instruction-current detector, a head-speed computing unit, and an identification structure. The voice coil motor moves a head above a disk, and performs recording/reproducing information on/from the disk. The detector detects back electromotive force of the voice coil motor and instruction current at intervals of a sampling time. The instruction-current detector detects an instruction current at intervals of a sampling time. The instruction current is given to the voice coil motor. The head-speed computing unit computes a head speed of the head from the back electromotive force at intervals of a sampling time. The identification structure estimates an error at intervals of a sampling time using the instruction current and the head speed. The error is a difference between a true resistance value and an estimated resistance value of the voice coil motor. In addition, the identification structure can minimize an estimated error defined as a difference between an estimated value ŷ(k) of the head speed and the head speed y(k), and employs \hat{b}₁ to calibrate the estimated error. \hat{b}₁ is determined by minimizing the estimated error. ŷ(k) and y(k) are defined by the equation (A):

ŷ(k)=y(k−1)+\hat{b}₀u(k−1)+\hat{b}₁u(k−2) (A).

y(k−1) denotes a head speed computed by the head-speed computing unit at the last sampling time k−1. k denotes the present sampling time. u(k−1) denotes an instruction current at the last sampling time k−1. u(k−2) denotes an instruction current at the last but one sampling time k−2. Unknown variables denoted by â₁, \hat{b}₀ are determined by minimizing the estimated error.

Embodiments will be described below with reference to the drawings.

### First Embodiment

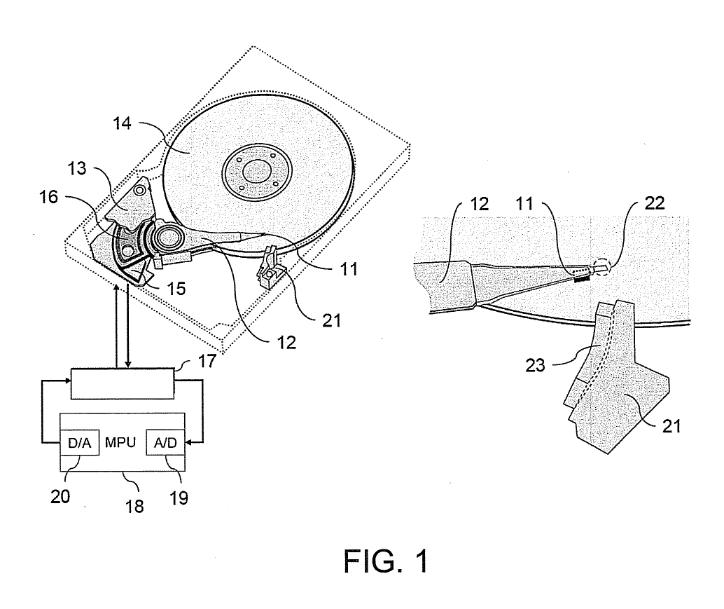

FIG. 1 is a schematic view showing a configuration of a ramp-unloading seek control device of a magnetic disk drive in accordance with a first embodiment. The ramp-unloading seek control device mainly includes a microprocessor unit (MPU) 18 that is provided to the magnetic disk drive.

A head 11 is supported by a carriage 12. The carriage 12 moves the head 11 by drive force of a voice coil motor (VCM) 13 toward the radial direction of a magnetic disk 14 that is capable of recording information magnetically.

One or more disks are mounted as the disk 14 and rotated by a spindle motor (not shown). VCM 13 includes a magnet 15 and a drive coil 16, and is driven by a current fed by a VCM drive circuit 17.

The VCM drive circuit 17 computes back electromotive force to feed the back electromotive force to an A/D converter 19. The back electromotive force is computed from the voltage across the VCM and current therethrough both provided by VCM 13; and the previously memorized resistance of the drive coil 16. The VCM drive circuit 17 includes a detector of back electromotive force. The detector detects instruction current to be given to VCM 13 at intervals of a predetermined time.

MPU (microprocessor unit) 18 computes a head speed y from the back electromotive force, and further computes the instruction current u to be passed through VCM 13 from the head speed y acquired and a targeted head speed at intervals of the predetermined time. The targeted head speed refers to an ideal head speed at which the head is to be unloaded onto the ramp mechanism, and is given by database or the like in software. The actual head speed is proportional to the back electromotive force.

MPU 18 converts the calculated instruction current into analog signals through a D/A convertor 20 to feed the analog signals to the VCM drive circuit 17.

MPU 18 includes an instruction-current detector and a head-speed computing unit. The instruction-current detector detects the instruction current at intervals of the predetermined time. The head-speed computing unit computes the head speed y from the back electromotive force detected by the detector of back electromotive force at intervals of the predetermined time.

The VCM drive circuit 17 converts the instruction current u fed by the D/A converter 20 into a drive current to feed the drive current to VCM 13.

A ramp mechanism 21 is mounted on a tangent line of the rotational locus of the tip of the carriage 12 such that the ramp mechanism 21 is next to the disk 14. When VCM 13 rotates the carriage 12 in the outer-circumference direction of the disk 14, a tab 22 mounted at the tip of the carriage 12 runs on a slope 23 of the ramp mechanism 21. The head 11 is evacuated from the area above the disk 14 to the ramp mechanism 21 as a result of the above action.

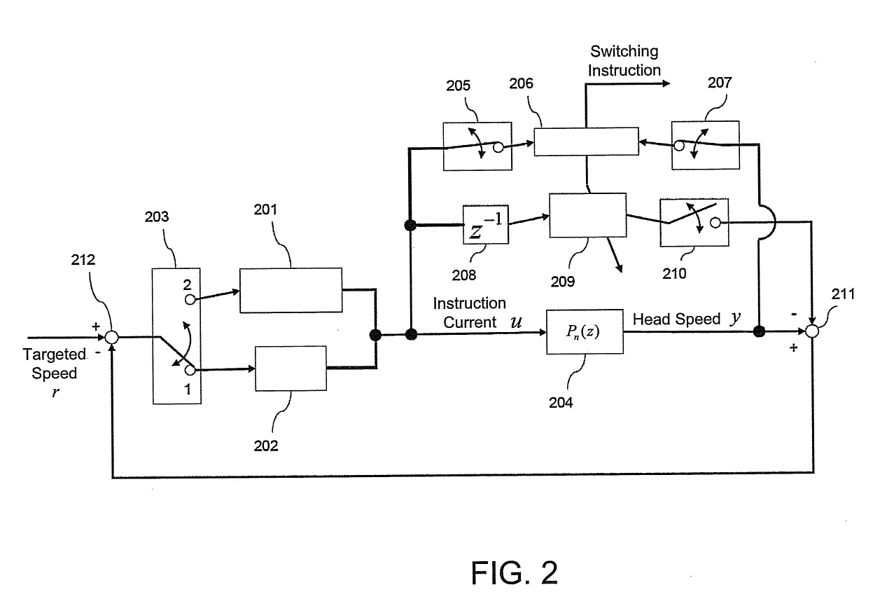

FIG. 2 is a diagram showing a ramp-unloading seek control system in the ramp-unloading seek control device for the magnetic disk drive in accordance with the first embodiment. This ramp-unloading seek control system can be installed in MPU 18 as software except a controlled object 204. The instruction current u in FIG. 2 denotes a current value. The head speed y corresponds to back electromotive force generated in the VCM and is provided by the head-speed computing unit.

This ramp-unloading seek control system is driven at intervals of the predetermined time, i.e., by a digital control system with a sampling time Tₛ. A transfer characteristic from the instruction current u to the head speed y is denoted as the controlled object 204. The instruction current u to the VCM drive circuit 17 is provided by the D/A converter 20.

An error computing section 212 (for detecting an error of the head speed) receives a signal of the calibrated speed outputted from an addition-subtraction processing section 211 at intervals of a sampling time. Meanwhile, the error computing section 212 acquires a targeted speed from a targeted-speed generating unit by referencing the data of the targeted speed relevant to an unloading seek speed at intervals of the sampling time. In other words, the targeted speed at each sampling time is read out from the data of the targeted speed relevant to the unloading seek speed. The error computing section 212 generates an error signal of speed showing a difference between the head speed and the targeted speed to input the generated error signal into a switch processing section 203. The switch processing section 203 including a switch switches to the terminal 1 or the terminal 2 in accordance with a switching instruction signal, and inputs the error signal of speed to either one of a high-gain controller 201 and a low-gain controller 202. The switch signal is outputted from an identification structure 206. The identification structure 206 adds a calibration gain to the resistance error of the VCM to minimize the resistance error, thereby unloading the head reliably. Both the high-gain controller 201 and the low-gain controller 202 include a feedback controller and an instruction unit while differing from each other in the gain of the feedback controller. The high-gain controller 201 controls with a high sensitivity to bring the head speed close to a final targeted speed. The low-gain controller 202 performs the initial rough control of the head speed with a low sensitivity. Two kinds of gains are included in the feedback controller. FIG. 2 shows an example that is provided with two kinds of feedback controllers.

Either one of the high-gain and low-gain controllers 201, 202 generates an instruction current u from the error signal of speed to input the instruction current u into the controlled object 204, a delay element 208, and a second switch-processing section 205. The error signal of speed is transmitted from the switch processing section 203.

The second switch-processing section 205 including a switch determines whether or not to input the instruction current u to the identification structure 206, in accordance with a switching-instruction signal from the identification structure 206. The delay unit 208 receives an instruction current u at each sampling time to store the instruction current u. The delay unit 208 inputs the instruction current u received at the last sampling time into the calibration gain 209 at the present sampling time.

The resistance error of VCM 13 depends on ambient temperatures. The calibration gain 209 changes with each suitable temperature and is determined by the identification structure 206. When the head is unloaded, the resistance error of VCM 13 prevents the head from running on the ramp mechanism precisely (precise unloading). The calibration gain 209 is required to be added to the resistance error for the precise unloading of the head 14 and is determined by the identification structure 206. In the initial control of the unloading, the calibration gain 209 is not determined at all. Firstly, the low-gain controller 202 roughly determines the calibration gain 209. Subsequently, the switch processing section 203 switches from the low-gain controller 202 to the high-gain controller 201. Then the high-gain controller 201 performs seek control on the basis of the roughly determined calibration gain 209 to evacuate the head 14 onto the ramp mechanism 24 for the unloading.

Meanwhile, the controlled object 204 is driven by the instruction current u transmitted from the high-gain controller 201 or the low-gain controller 202. Then a head speed is computed by MPU inside the controlled object 204. The head speed computed is inputted into an addition-and-subtraction processing unit 211 and a third switch processing section 207. The addition-subtraction processing section 211 subtracts a calibration signal from the signal of the received head speed at each sampling time to input the calibration signal to the error computing section 212. The calibration signal is a signal of the head speed transmitted from a fourth switch processing section 210.

The third switch processing section 207 including a switch determines in accordance with a switching-instruction signal from the identification structure 206 whether or not to input the signal of the head speed to the identification structure 206. The signal of the head speed transmitted from the controlled object 204 has been transmitted from the controlled object 204. The fourth switch processing section 210 including a switch determines whether or not to input a signal to the addition-subtraction processing section 211, in accordance with a switching instruction signal from the identification structure 206. The signal has been acquired by multiplying an instruction signal by the calibration gain 209. The instruction signal is received at the last sampling time from the delay element 208.

Meanwhile, the identification structure 206 generates the switching instruction signal and the calibration gain 209 at each sampling time from the instruction current u and the signal of head speed y. The instruction current u and the signal of head speed y have been received from the second switch processing section 205 and the third switch processing section 205, respectively. The switching instruction signal is to be inputted into the four switch processing sections 203, 205, 207, and 210.

The switch processing section 205, the identification structure 206, the switch processing section 207, the delay element 208, the calibration gain 209, and the switch processing section 210 shown in FIG. 2 are included in the software installed on MPU 18 shown in FIG. 1 in the first embodiment.

The ramp-unloading seek control system shown in FIG. 2 in accordance with the first embodiment includes a speed control system combined with the identification structure 206. The speed control system causes the head speed to follow the targeted speed. The identification structure 206 identifies variations in characteristics of the controlled object 204 arising from the variation in the resistance across the drive coil of VCM 13.

The ramp-unloading seek control system in FIG. 2 has a first action and a second action. The first and second actions are each performed by switching the switch processing sections 203, 205, 207, and 210 in accordance with switching instruction signals outputted from the identification structure 206.

The first action refers to the action prior to the minimization of an estimated error. In other words, the first action identifies a variation in the characteristics of the controlled object 204 through the identification structure 206 to compute the calibration gain 209 for calibrating the variation. The variation is caused by the variation in the resistance across the drive coil 16 of VCM 13.

The second action calibrates the signal of the head speed u using the calibration gain 209 computed in the first action, and causes the head speed y to follow an unloading seek speed as the targeted speed by using the calibrated signal of the head speed y. In other words, the second action evacuates the head 11 onto the ramp mechanism 24.

The variations in the characteristics of the targeted object 204 will be described below. Specifically, the first action of the ramp-unloading seek control system in accordance with the first embodiment will be described in relation to the identification structure 206 that identifies the variations.

As described above, the head speed computed in the controlled object 204 is acquired using the following equation:

(Back Electromotive Force)=(Voltage across Coil)−(Coil Resistance)×(Current through Coil).

The basis is that the head speed is proportional to back electromotive force across the drive coil (referred to as “coil” simply) of the VCM. The coil current denotes the current passing through the coil. If the resistance (the coil resistance) of the VCM is evaluated exactly, the back electromotive force estimated from the above equation can provide an exact head speed. Unfortunately, an error mostly occurs between a resistance estimated by some means and a true resistance. “The resistance estimated by some means,” i.e., the estimated resistance of the VCM, refers to a design resistance thereof or an estimated resistance that is a total resistance of the design resistance and its variation with temperature. The variation with temperature is estimated from the temperature of the VCM that has been measured by some temperature sensors. A true resistance value of the VCM cannot be determined by any means. A unit to estimate a difference (an error) between the true resistance value and an estimated resistance value at intervals of a prescribed time will be described below.

A transfer function from the instruction current u given by the VCM drive circuit 17 to the head speed y is derived as being the equation (1) defined as

$$y ( t ) = \{ \frac{{K}_{T}^{2}}{Js} + Ls + ( {R}_{vcm} - {R}_{est} ) \} u ( t ) . \qquad ( 1 )$$

The equation (1) includes the following parameters:
K_{T} denoting the torque constant of the VCM;
J denoting the inertia moment of the carriage for carrying the head;
L denoting the inductance of the coil; and
R_{vcm} denoting the true coil resistance;
Rₑₛₜ denoting the estimated coil resistance; and
R_{vcm}−Rₑₛₜ denoting the error between the estimated coil resistance and the true coil resistance.

If the sampling time Tₛ of the ramp-unloading seek control system in FIG. 2 is much larger than the time constant of the coil inductance L, the transfer characteristic discretized by zero-order hold are approximated by the equation (2) defined as

$$y ( k ) = ( \frac{b}{z - 1} + θ {z}^{- 1} ) u ( k ) . \qquad ( 2 )$$

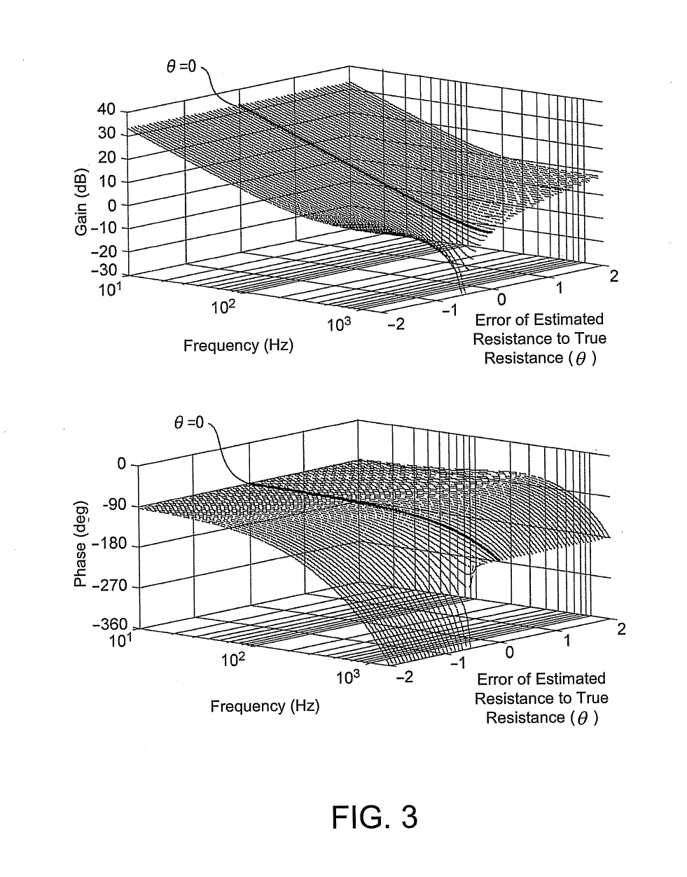

The first term of the right side in the equation (2) is a discrete integral of the gain b. The second term θ of the right side is a coefficient that arises from the error (difference) between the estimated resistance and true resistance values of the coil. The equation (2) shows that the controlled object 204 becomes a discrete integral of the gain b if the error between the estimated coil resistance value Rₑₛₜ and the true coil resistance value R_{vcm} is zero. Meanwhile, the equation (2) shows that the controlled object 204 has frequency characteristics (frequency responses) that vary in the high-frequency region and depend on the coefficient θ as shown in FIG. 3 if the error between the estimated coil resistance value Rₑₛₜ and the true coil resistance value R_{vcm} is nonzero. The frequency responses have been computed in FIG. 3, provided that b=1 and the sampling time Tₛ=350 μs.

Preferably, the coefficient θ is set to zero because the variation in the frequency characteristics shown in FIG. 3 prevents enhancement of the band frequency of the ramp-unloading seek control system to cause the head speed to follow the targeted speed. For that reason, the background art has tried to compute calibrated values by calibration seek and set θ to zero indirectly.

In contrast, the present embodiment directly provides the coefficient θ of the equation (2). The identification structure 206 is to seek the coefficient θ in FIG. 2. A method to estimate (identify) the coefficient θ in the identification structure 206 will be described below.

The unknown coefficient θ taken into consideration, the equation (2) of the controlled object 204 is transformed into the equation (3) defined as

$$\begin{matrix}y ( k ) = ( \frac{b}{z - 1} + θ {z}^{- 1} ) u ( k ) \\ = \{ {z}^{- 1} \cdot \frac{( θ + b ) z - θ}{z - 1} \} u ( k ) \\ = ( {z}^{- 1} \cdot \frac{{b}_{0} z - {b}_{1}}{z - 1} ) u ( k ) \\ = P ( z ) u ( k ) .\end{matrix} \qquad ( 3 )$$

In the equation (3), y(k) and u(k) denote the back electromotive force (head speed) and the instruction current at each sampling time, respectively. If the low frequency characteristic of an actual controlled object is taken into consideration and the discrete integral 1/(z−1) is replaced with the following equation (4), the output y(k) of the controlled object is expressed by the following difference equation (5). The equations (4) and (5) are defined as

$$P ( z ) = {z}^{- 1} \cdot \frac{{b}_{0} z - {b}_{1}}{z - {a}_{1}} \qquad ( 4 )$$

and

y(k)=−a₁y(k−1)+b₀u(k−1)+b₁u(k−2) (5).

A value ŷ(k) further estimated from the estimated value of the output y(k) of the controlled object 204 is expressed by the following equation (6), provided that a₁, b₀, b₁ of the equation (5) are unknown coefficients â₁, \hat{b}₀, \hat{b}₁ to be estimated in the identification structure 206. The output y(k) is an estimated value of a head speed computed at intervals of a sampling time (predetermined time). The equation (6) is defined as

ŷ(k)=â₁y(k−1)+\hat{b}₀u(k−1)+\hat{b}₁u(k−2) (6).

The unknown parameters â₁, \hat{b}₀, \hat{b}₁ of the equation (6) can be identified by a sequential identification method that minimizes the square sum of the estimated error expressed by the right side of the following equation (7), i.e., the difference between the output y(k) and its estimated value ŷ(k). The equation (6) is defined as

ε(k)=y(k)−ŷ(k) (7).

Examples of the sequential identification method include RLS (Recursive Least Square) and LMS (Least Mean Square). If the sequential identification for the equations (6), (7) is completed, the estimated value of the coefficient θ arising from the difference between the estimated resistance and the true resistance can be determined as the following equation (8) from the identified parameter \hat{b}₁. The equation (8) is defined as

\hat{θ}=−\hat{b}₁ (8).

The estimated \hat{θ} is the calibration gain itself.

Although lot-to-lot variations in the inertia moment and torque of the carriage are likely to occur, the moment and the torque are treated as unknown parameters in the equation (6). As a result, the moment and the torque are identified together with the head speed. Thus, more robust calibration values are computed by the present embodiment than by the background art.

Preferably, the input signal into the controlled object 204 includes many frequency components, i.e., establishes the persistently exciting characteristic (referred to as PE below), for the above-described sequential identification. Actions of the ramp-unloading seek control system in accordance with the first embodiment will be described below. In the first-step action (sequential identification), the targeted speed r to be inputted to the error computing section 212 is given a dummy white noise or random signals, such that that PE of the input signal u(k) is established.

If a signal is given to determine a step prior to the minimization of the estimated error (the first-step action), the targeted speed r is given the dummy white noise or the random signals. If the signal is given to determine a step subsequent to the minimization of the estimated error (the second-step action), the targeted speed r is given a head speed necessary for the ramp-unloading seek of the head.

The coefficient θ, i.e., the high-frequency characteristics of the controlled object 204, are unknown in the first-step action. Accordingly, high gain of the feedback controller possibly causes a closed loop system to be unstable depending on θ. A variation range of θ being taken into account, the gain of the feedback controller is set low so that the stability of the ramp-unloading seek system is acquired in the first-step action.

As described above, if the signal is given to determine the first-step action prior to the minimization of the estimated error, the identification structure 206 outputs a switching instruction signal such that four switch processing sections 203, 205, 207, 210 perform the following actions:

the switch processing section 203 connects its switch to the terminal 1;
the switch processing section 205 switches on;
the switch processing section 207 switches on; and
the switch processing section 210 switches off.

The second-step action of the ramp-unloading seek control system in accordance with the first embodiment will be described below as an action subsequent to the first-step action.

When the estimated error of the estimated head speed ŷ(k) to the head speed is determined to be minimized subsequently to the first-step action, i.e., the computation of the calibration gain 209 is finished, a signal is given to determine the action to be the second-step action subsequent to the minimization of the estimated error. The computation of the calibration gain 209 is to calibrate variations in characteristics of the controlled object 204. Then the identification structure 206 outputs a switch processing signal so that four switch processing sections 203, 205, 207, and 210 perform the following actions:

the switch processing section 203 connects its switch to the terminal 2;
the switch processing section 205 switches off;
the switch processing section 207 switches off; and
the switch processing section 210 switches on.
In the second-step action, the gain of the feedback controller is set high.

When the four switch processing sections 203, 205, 207, and 210 have performed their actions, the ramp-unloading seek control system shown in FIG. 2 performs an action based on the following equation (9) for the controlled object 204 (the equation (3)). The equation (9) is defined as

$$y ( k ) = ( \frac{b}{z - 1} + θ {z}^{- 1} ) u ( k ) - \hat{θ} {z}^{- 1} \cdot u ( k ) . \qquad ( 9 )$$

The equation (9) has been identified in the first-step action so that \hat{θ}≈θ. As a result, the equation (9) is transformed into the following equation (10). The equation (10) is defined as

$$y ( k ) \approx ( \frac{b}{z - 1} ) u ( k ) . \qquad ( 10 )$$

The equation (10) shows that the controlled object 204 approaches an ideal discrete-series integral by the calibration action of the equation (9) that calibrates using \hat{θ} (calibration gain 209) identified in the first-step action.

The controlled object (the equation (10)) having been calibrated is free from variations in its characteristics at high frequencies. Thus, the switch processing section 203 connects its switch to the terminal 2, and uses the high-gain controller to set high the band of the speed control system. The above-described actions enable it to cause the head speed to follow the targeted speed given by the ramp-unloading seek control.

The above-described actions are fundamental actions of the ramp-unloading seek control device.

The ramp-unloading seek control device has been tested by conducting an experiment using a 2.5-inch magnetic disk device (actual device). The test result will be described below as a specific example.

In the experiment, RLS has been employed as a serial identification technique in the first-step action. The equation (6) is transformed into the following equation (11) expressed in vector notation. The equation (11) is defined as

ŷ(k)=ζ(k)^{T}Θ (11).

Θ and ζ(k) are specified by the following equations (12). The equations (12) are defined as

$$Θ = [ \begin{matrix}- {\hat{a}}_{1} \\ {\hat{b}}_{0} \\ {\hat{b}}_{1}\end{matrix} ] , ζ ( k ) = [ \begin{matrix}y ( k - 1 ) \\ u ( k - 1 ) \\ u ( k - 2 )\end{matrix} ] . \qquad ( 12 )$$

The sequential identification of the unknown parameter vector Θ of the equation (11) is executed with RLS using the following equations (13) to (15). The equations (13) to (15) are defined as

$$Θ ( k ) = Θ ( k - 1 ) + \frac{Γ ( k - 1 ) ζ ( k )}{1 + {ζ}^{T} ( k ) Γ ( k - 1 ) ζ ( k )} ɛ ( k ) , \qquad ( 13 )$$

ε(k)=y(k)−ζ^{T}(k)Θ(k−1) (14),

and

$$Γ ( k ) = Γ ( k - 1 ) - \frac{Γ ( k - 1 ) ζ ( k ) {ζ}^{T} ( k ) Γ ( k - 1 )}{1 + {ζ}^{T} ( k ) Γ ( k - 1 ) ζ ( k )} . \qquad ( 15 )$$

Initial values have been given to the unknown parameter Θ and the covariance matrix Γ by the following equations (16). The equations (16) are defined as

$$Θ ( 0 ) = [ \begin{matrix}0 \\ 0 \\ 0\end{matrix} ] , Γ ( 0 ) = [ \begin{matrix}{10}^{3} & & \\ & {10}^{3} & \\ & & {10}^{3}\end{matrix} ] . \qquad ( 16 )$$

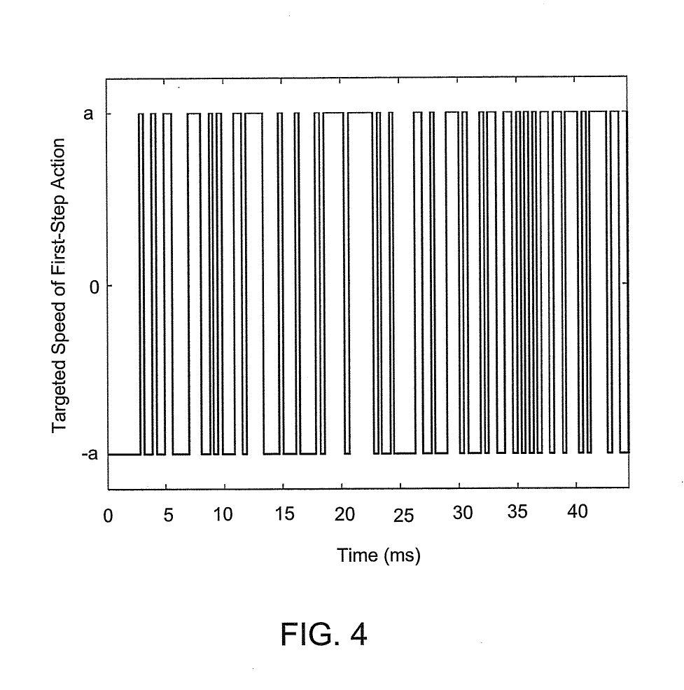

The dummy white signal shown in FIG. 4 has been employed as the targeted speed r to be fed during the sequential identification. The dummy white signal has been normalized with its amplitude denoted by a in FIG. 4.

When the sequential identifications of the equations (13) to (16) are updated every sampling time, the covariance matrix Γ of the equation (15) converges to zero and the second term of the right side of the equation (15) also converges to zero. At this point, the estimated error of the resistance of the VCM is minimized. The switching from the first-step action to the second-step action means the ending of identifying the calibration gain 209. The ending will be determined by the following formula (17) when the updated amount of the covariance matrix of the second term is smaller than a threshold δ specified. The formula (17) is defined as

$$\frac{Γ ( k - 1 ) ζ ( k ) {ζ}^{T} ( k ) Γ ( k - 1 )}{1 + {ζ}^{T} ( k ) Γ ( k - 1 ) ζ ( k )} \leq δ I . \qquad ( 17 )$$

The equation (17) corresponds to the switching instruction signal outputted by the identification structure 206. In addition to the above-mentioned example, selecting various switching instruction signals is available, e.g., when the change rate for each sampling time of the unknown parameter equals to a threshold or smaller.

A PI controller is employed for the high-gain controller 201 and the low-gain controller 202. The P gain and I gain of the high-gain controller 201 has been set, such that the band, gain margin, and phase margin of the speed control system are about 250 Hz, 10 dB, and 40 deg, respectively. The P gain and I gain of the low-gain controller 201 are set half those of the high-gain controller 201.

The head speed at each sampling time and the value of the calibration gain 209 are acquired by repeating the ramp-unloading seek control several times on the basis of the above-described parameter settings.

Rₑₛₜ in the equation (1) is given a value previously estimated by some means in the first-step action of the ramp-unloading seek control system in accordance with the first embodiment. In an actual magnetic disk device, the carriage of the head is pressed to the ramp mechanism in the dead-end direction thereof prior to the loading seek control to provide the coil resistance estimated from zero back electromotive force as described in the background art. Whether or not to be able to identify \hat{θ} (the calibration gain 209) has been examined by giving Rₑₛₜ a random value at each test of the ramp-unloading seek control. In addition, the range of Rₑₛₜ to be provided randomly has been determined from the actual variations in the coil resistance.

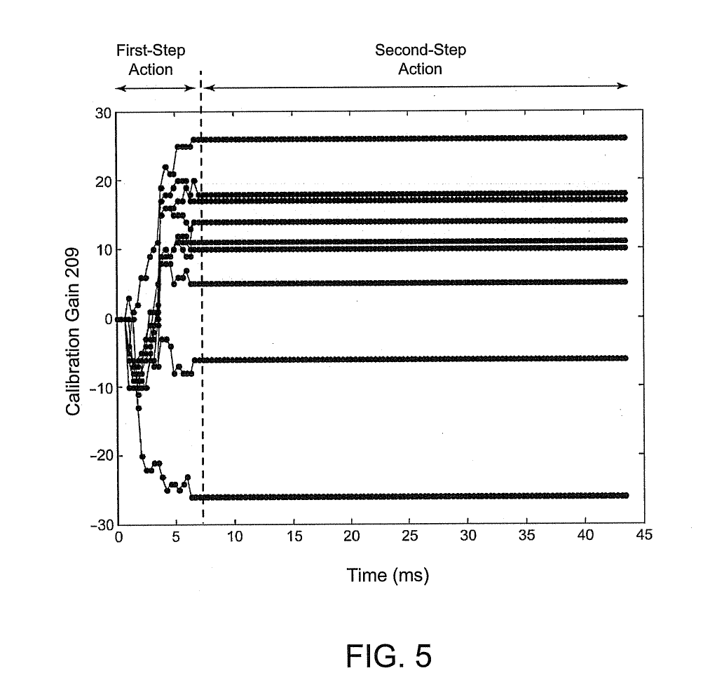

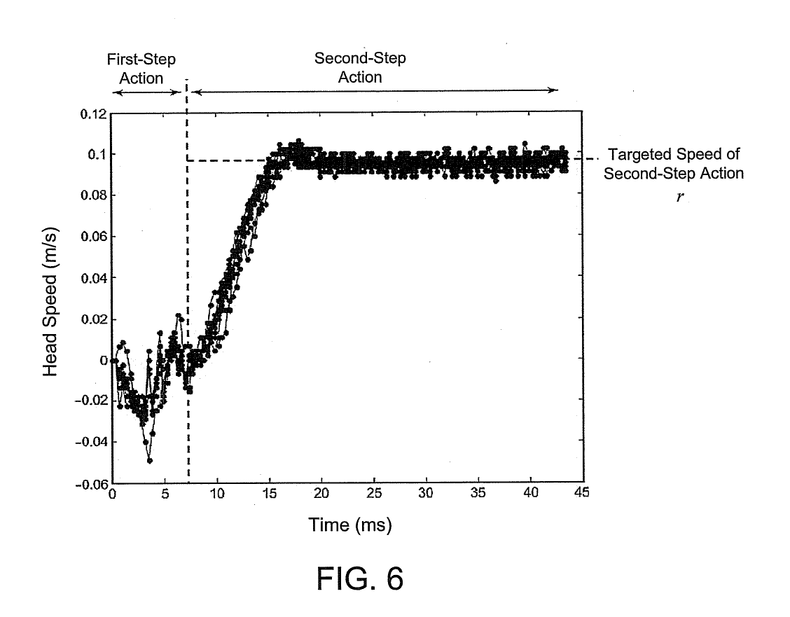

FIG. 5 is a graph showing a time history of \hat{θ} (the calibration gain 209). FIG. 6 is a graph showing a time history of the head speed. The graph of FIG. 5 shows that the first-step action of the ramp-unloading seek control system identifies \hat{θ} (the calibration gain 209) in accordance with the first embodiment. The graph of FIG. 6 shows that the second-step action causes the head speed to stably follow the targeted speed r for the ramp-unloading seek control, thereby allowing it to confirm that the calibration gain \hat{θ} identified by the first-step action is exact.

The above results have confirmed the effect of the ramp-unloading seek control system of the first embodiment.

### Second Embodiment

A ramp-unloading seek control device for a magnetic disk drive in accordance with a second embodiment will be described below.

As described in the first embodiment, the transfer characteristics of the ramp-unloading seek control system in accordance with the first embodiment have been expressed by the equation (2), and enable the ramp-unloading seek control system to stably perform by the action of the equation (9) if the unknown parameter θ expressing a variation in the coil resistance is exactly estimated. The first embodiment has expanded the equation (1) as being the equation (5), and has identified the calibration gain in a form that includes the inertia moment and torque constant of the carriage as unknown parameter vectors. In contrast, the second embodiment estimates just the unknown coefficient θ of the equation (1), assuming that the inertia moment and torque constant of the carriage are known and the variations therein are thoroughly small. Accordingly, the second embodiment can reduce the number of the switch processing sections that the first embodiment has needed, and reduce also the computational effort for updating parameters as a result of only one unknown parameter to be estimated. The second embodiment can reduce the computational load when installed at MPU 18 as software.

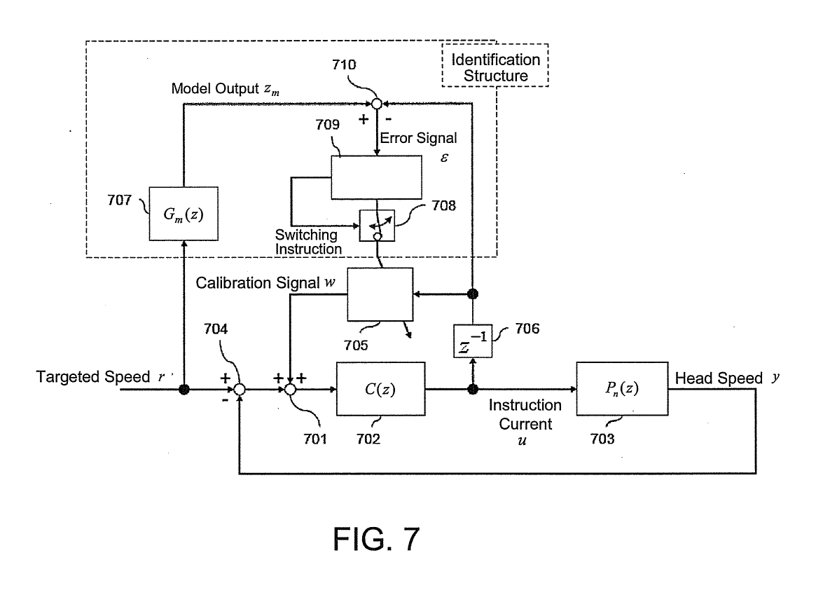

FIG. 7 is a diagram showing a ramp-unloading seek control system in accordance with the second embodiment. An error computing section 704 (for detecting an error of the head speed) receives a signal of the head speed from a controlled object 703 while receiving data of the targeted speed relevant to a ramp-unloading seek speed every sampling time. The error computing section 704 reads out the targeted speed relevant to the ramp-unloading seek speed from the data of the targeted speed at each sampling time. The error computing section 704 generates a speed-error signal showing a difference between the head speed and the targeted speed to input the generated speed-error signal to an adder 701. The adder 701 adds the speed-error signal from the error computing section 704 and a calibration signal from a calibration gain 705 to generate a calibrated speed-error signal, and inputs the calibrated signal into a controller 702. The controller 702 generates an instruction current u, which the controller 702 has received from the adder 701, and inputs the instruction current u into the controlled object 703 and a delay element 706. The controlled object 703 is driven in accordance with the instruction current u outputted from the controller 702. MPU inside the controlled object 703 computes a head speed. The computed head speed is inputted into the error computing section 704. The delay element 706 receives the instruction current u at each sampling time, and memorizes the instruction current u. Then, the delay element 706 inputs the instruction current u received at the last sampling time into a calibration gain 705 and an error-computing section 710 at the present sampling time.

Meanwhile, a model 707 reads out the targeted speed at each sampling time to generate a model output, and subsequently inputs the model output into the error computing section 710. The error computing section 710 generates an error signal, i.e., a difference between the instruction current received at the last sampling time and the model output fed by the model 707. Then the error computing section 710 inputs the error signal into a parameter regulating structure 709. The parameter regulating structure 709 generates a corrective signal for the calibration gain 705 and a switching instruction signal to a switch processing section 708 in accordance with the error signal from the error computing section 710. Subsequently, the corrective signal and the switching-instruction signal each are inputted into the switch processing section 708. The switch processing section 708 determines whether or not to input the corrective signal into the calibration gain 705 in accordance with the switching instruction signal from the parameter regulating structure 709. The calibration gain 705 generates a calibration signal w from the instruction current given by the delay element 706 at the last sampling time to input the calibration signal into the adder 701 at the present sampling time. A model 707, the error computing section 710, the parameter regulating structure 709, and the switch processing section 708 configures the “identification structure” corresponding to that in the ramp-unloading seek control system of the first embodiment shown in FIG. 2.

The ramp-unloading seek control system shown in FIG. 7 has a first-step action and a second-step action that follows the first-step action as well as in the first embodiment. Both the first-step and second-step actions are performed by switching the switch processing section 708 in accordance with the switching-instruction signal outputted by the parameter-regulating structure 709. In the second embodiment, the first-step action computes a calibration gain 705 to calibrate a variation in characteristics of the controlled object 703 as well as the first-step action in the first embodiment. The second-step action calibrates a speed-error signal showing a difference between a head speed and a targeted speed using the calibration gain 705, and causes the head speed to follow a ramp-unloading seek speed given as the targeted speed using the calibrated speed-error signal, thereby evacuating the head 11 onto the ramp mechanism 24. The controlled object 703 is the same as the controlled object 204 in FIG. 2 showing the ramp-unloading seek control system of the first embodiment.

The first-step action of the ramp-unloading seek control system will be described below with reference to FIG. 7.

The operation principle of the parameter regulating structure 709 in the second embodiment will be described. The controlled object 703 is assumed to be expressed by the following equation (18) using an unknown coefficient 9 due to a variation in the coil resistance as well as by equation (2). The equation (18) is defined as

P(z)=Pₙ(z)+θz⁻¹ (18).

The transfer characteristic (z) of the controlled object 703 is assumed to be an ideal controlled object model without a variation in the voice coil resistance. The instruction current is transferred to the head speed through the transfer characteristic (z). The model Gₘ(z) in FIG. 7 is a transfer function expressed by the following equation (19). The equation (19) is defined as

$${G}_{m} ( z ) = \frac{{z}^{- 1} C ( z )}{1 + {P}_{n} ( z ) C ( z )} . \qquad ( 19 )$$

The model Gₘ(z) generates a model output zₘ from the targeted speed r. Then the following equation (20) holds. The equation (20) is defined as

$${z}_{m} ( k ) = \frac{{z}^{- 1} C ( z )}{1 + {P}_{n} ( z ) C ( z )} r ( k ) . \qquad ( 20 )$$

The calibrated signal w is computed from the following equation (21) using the estimated value \hat{θ}(k) of θ that is updated every sampling time. The equation (21) is defined as

w(k)=\hat{θ}(k)u(k−1) (21).

Thus, the error signal s, which is an output of the error-computing section 710 in FIG. 7, is computed as being the following equation (22) using the equations (18) to (21). The equation (22) is defined as

$$\begin{matrix}ɛ ( k ) = u ( k - 1 ) - {z}_{m} ( k ) \\ = \frac{{z}^{- 1} C ( z )}{1 + P ( z ) C ( z )} ( r ( k ) + w ( k ) ) - {z}_{m} ( k ) \\ = \frac{{z}^{- 1} C ( z )}{1 + ( {P}_{n} ( z ) + θ {z}^{- 1} ) C ( z )} \\ ( \frac{1 + {P}_{n} ( z ) C ( z )}{{z}^{- 1} C ( z )} {z}_{m} ( k ) + \hat{θ} ( k ) u ( k - 1 ) ) - {z}_{m} ( k ) .\end{matrix} \qquad ( 22 )$$

The equation (22) is further transformed into the following equation (23). The equation (23) is defined as

$$\{ 1 + ( {P}_{n} ( z ) + θ {z}^{- 1} ) C ( z ) \} ɛ ( k ) = {z}^{- 1} C ( z ) \hat{θ} ( k ) u ( k - 1 ) - {z}^{- 1} C ( z ) θ u ( k - 1 ) \\ ɛ ( k ) = \frac{C ( z )}{1 + {P}_{n} ( z ) C ( z )} ( \hat{θ} ( k ) - θ ) u ( k - 2 ) \\ ɛ ( k ) = \frac{C ( z )}{1 + {P}_{n} ( z ) C ( z )} ψ ( k ) ζ ( k ) . \qquad ( 23 )$$

zₘ(k) is a model output in FIG. 7. C(z) is a transfer characteristic of the feedback controller that computes an instruction current from the error between the targeted speed and the head speed. The equation (23) forms an error equation in a Model Reference Adaptive Control. The following formula (24) is a transfer part of the equation (23) and is defined as

$$\frac{C ( z )}{1 + {P}_{n} ( z ) C ( z )} . \qquad ( 24 )$$

If the transfer part is strictly positive real (the vector locus stays in the right half plane on the complex plane), k→∞ yields the following formula (25) on the basis of a proper parameter regulation law. The formula (25) is defined as

ε(k)→0 (25).

In other words, k→>∞ further yields the following formula (26), thereby allowing it to estimate an unknown coefficient 9 arising from a variation in the coil resistance. The formula (26) is defined as

\hat{θ}(k)→θ (26).

The strict positive realness of the formula (24) will be discussed below.

The formula (24) is transformed into the following formula (28), provided that:
the controller C(z) in the formula (24) is a PI controller expressed by the following equation (27); and
a controlled object model Pₙ(z) is b/(z−1). The equation (27) and the formula (28) are defined as

$$\begin{matrix}C ( z ) = \frac{α z - β}{z - 1} \\ and & ( 27 ) \\ \frac{( z - 1 ) ( α z - β )}{{( z - 1 )}^{2} + b ( α z - β )} . & ( 28 )\end{matrix}$$

Then, the formula (28), i.e., the formula (24), has an unstable zero 1 and cannot be strictly positive real. If the controlled object model Pₙ(z) is selected as being the following transfer function (29) having a low pass characteristic and conforming to b/(z−1) at high frequencies, the equation (24) has no unstable zero and can be strictly positive real. The transfer function (29) is defined as

$${P}_{n} ( z ) = \frac{b}{z - γ} ( γ < 1 ) . \qquad ( 29 )$$

The parameter regulation law is known to commonly use the following equation (30) if the formula (24) is strictly positive real. The equation (30) is defined as

\hat{θ}(k)=\hat{θ}(k−1)−δζ(k)ε(k) (Γ>0) (30).

The parameter regulating structure 709 multiplies an error ε by the instruction current u at the last but one sampling time k−2 by regulation-law gain Γ to yield a multiplication value. The error s is a difference between a model output zₘ and the instruction current u at the last sampling time k−1. The parameter regulating structure 709 subtracts the multiplication value from the estimated value \hat{θ}(k−1) at the last sampling time k−1 to compute \hat{θ}(k), i.e., the calibration gain 705 that is an estimated value of the coil-resistance error at the present sampling time k. The equation (30) is transformed into the following equation (31), provided that:
ζ(k) of the equation (30) is employed for the instruction current u at the last but one sampling time k−2; and
the equation (22) is employed as ε(k). The equation (31) is defined as

\hat{θ}(k)=\hat{θ}(k−1)−Γu(k−2)(u(k−1)−zₘ(k)) (31).

\hat{θ}(k) and \hat{θ}(k−1) denote estimated errors arising from variations in resistance at the present sampling time k and at the last sampling time k−1, respectively. The errors refer to the difference between a true resistance value and its estimated resistance value.

The parameter regulating structure 709 performs two steps of actions. The first-step action inputs a dummy white signal into the targeted speed r to estimate the calibration gain 705. After the estimation of the calibration gain, the second-step action starts to give a targeted speed for the ramp-unloading seek control to the targeted speed r and perform a ramp-unloading seek action. The switch processing section 708 performs the switching of each action. The switch processing section 708 determines ON or OFF of the parameter regulation law of the calibration gain 705 in accordance with the switching instructions from the parameter regulating structure 709. The switch processing section 708 turns ON and OFF the parameter regulation law in the first-step and second-step actions, respectively. The parameter regulation law is turned OFF when the error between the instruction current u and the model output zₘ becomes sufficiently small.

The operation principle of the ramp-unloading seek control system has been described in accordance with the second embodiment.

A computer simulation of the second embodiment will be executed as an example below.

A controlled object P(z), a controlled object model Pₙ(z) without a variation in the coil resistance, and a controller C(z) have been determined by the following equations (32) to (34). The equations (32) to (34) are defined as

$$\begin{matrix}P ( z ) = \frac{0.04}{z - 1} + θ {z}^{- 1} ( - 0.12 \leq θ < 0.12 ) , & ( 32 ) \\ {P}_{n} ( z ) = \frac{0.04}{z - 0.9891} , \\ and & ( 33 ) \\ C ( z ) = \frac{15 z - 11}{z - 1} . & ( 34 )\end{matrix}$$

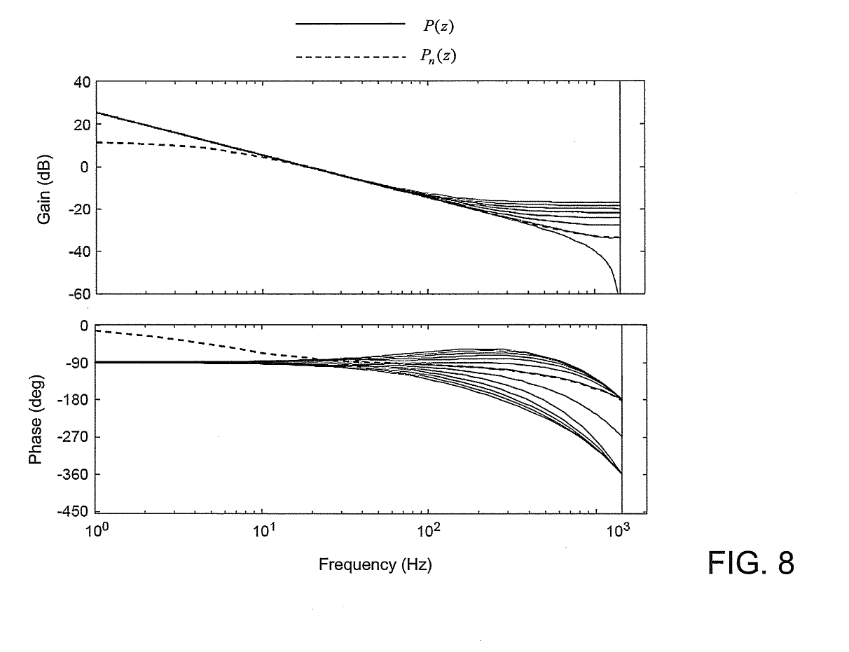

The controlled object P(z) expressed by the equation (32) is defined, provided that the variation in the coil resistance ranges from −0.12Ω to 0.12Ω and occurs at intervals of 0.02Ω. FIG. 8 shows the frequency responses of the equations (32) and (33). The solid line and the dotted line denote the controlled object P(z) expressed by the equation (32) and the controlled object model Pₙ(z) expressed by the equation (33) in FIG. 8, respectively. FIG. 8 shows that the characteristics of the controlled object start to vary at around 100 Hz in response to the variation in the coil resistance that ranges from −0.12Ω to 0.12Ω.

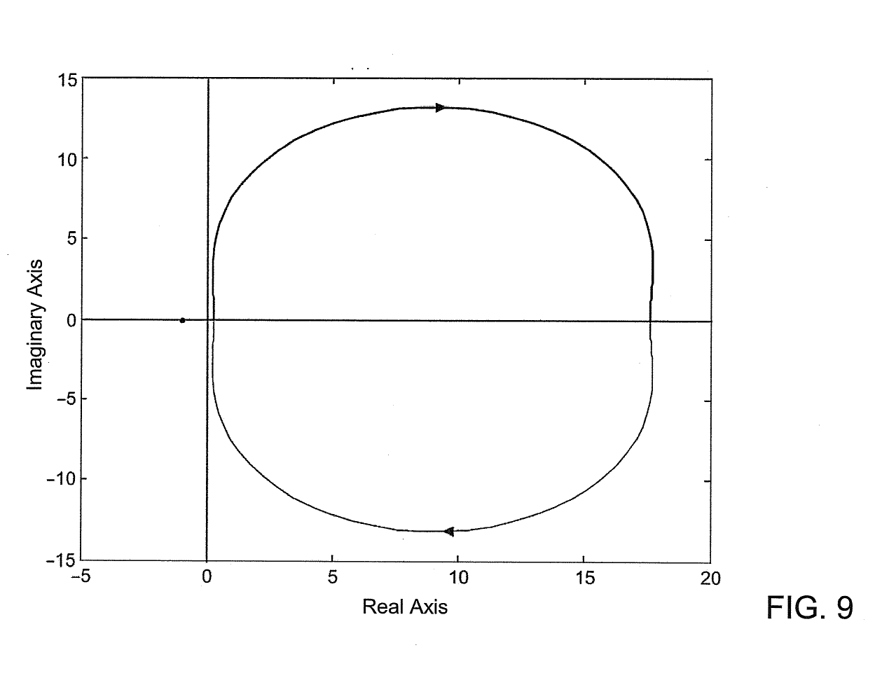

The formula (24), i.e., the transfer function of an error equation, is computed using the equations (32) and (33). The transfer function is drawn as a vector locus shown in FIG. 9. The vector locus stays in the right half plane on the complex plane and shows that the formula (24) is strictly positive real. Thus, the parameter regulation law of the equation (30) can be used.

The sampling time and regulation-law gain of the ramp-unloading seek control system have been assumed to be Tₛ=350 μs and Γ=3×10⁻⁶, respectively. When the characteristics of an actual magnetic disk device are taken into account, bias force and normally-distributed random noise have been given to the instruction current u and the head speed y as disturbance, respectively.

The actions of the ramp-unloading seek control system shown in FIG. 7 have been checked using a computer simulation under the above-mentioned parameter settings.

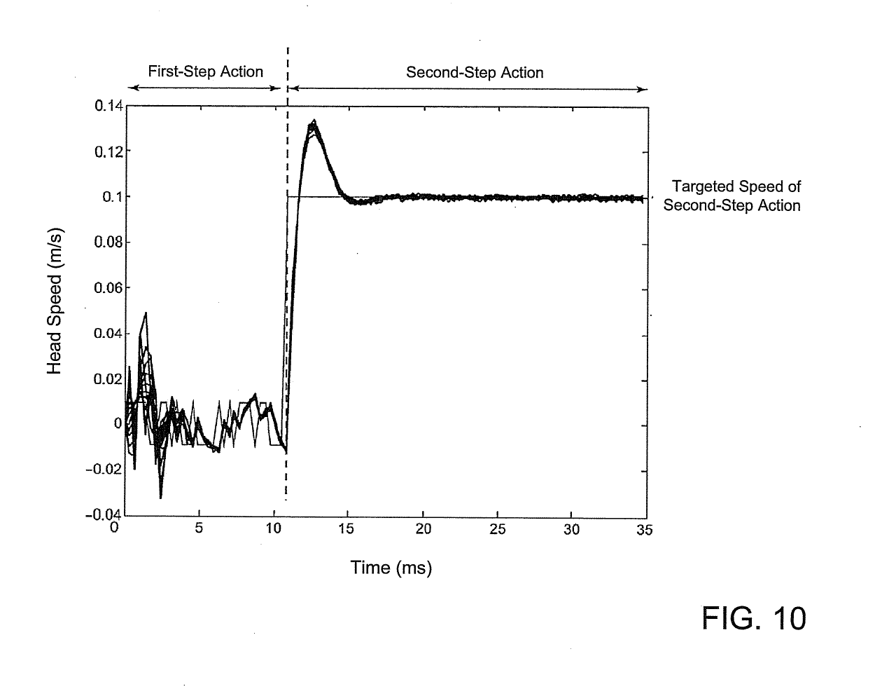

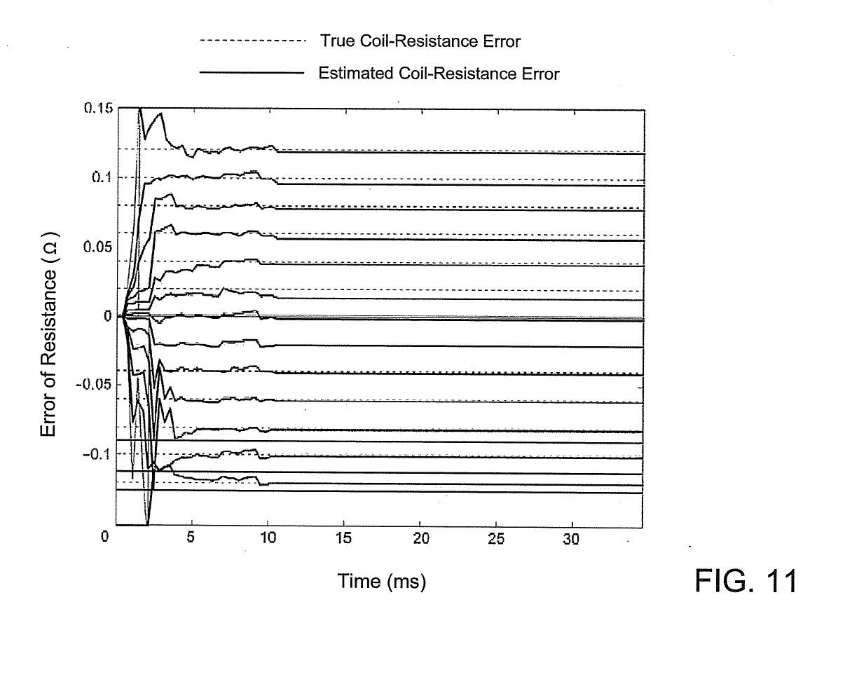

FIG. 10 is a graph showing responses of the head speed in the first-step and second-step actions where the variation in the coil resistance ranges from −0.12Ω to 0.12Ω and occurs at intervals of 0.02Ω. The first-step action feeds a quasi-random noise to the targeted speed to estimate the coil resistance in the range from 0 to 10 ms. The second-step action causes the head speed to follow a targeted head speed of 0.1 m/s. FIG. 11 is a graph showing estimation behavior of the coil resistance. The graph shows that the parameter regulation law regulates the estimated coil-resistance error denoted by the solid line and causes the estimated coil-resistance error to follow the true coil-resistance error denoted by the dotted line.

Thus, the second embodiment has been successfully checked as a ramp-unloading seek control system.

While a certain embodiment of the invention has been described, the embodiment has been presented by way of examples only, and is not intended to limit the scope of the inventions. Indeed, the novel elements and apparatuses described herein may be embodied in a variety of other forms; furthermore, various omissions, substitutions and changes in the form of the methods described herein may be made without departing from the spirit of the invention. The accompanying claims and their equivalents are intended to cover such forms or modifications as would fall within the scope and spirit of the invention.

What is claimed is:

1. A ramp-unloading seek control device for a magnetic disk drive, the device comprising:
a voice coil motor to move a head above a disk, the head recording/reproducing information on/from the disk;
a detector to detect back electromotive force of the voice coil motor at intervals of a sampling time;
an instruction-current detector to detect an instruction current at intervals of a sampling time, the instruction current given to the voice coil motor;
a head-speed computing unit to compute a head speed of the head from the back electromotive force at intervals of a sampling time;
an identification structure to estimate an error at intervals of a sampling time using the instruction current and the head speed, the error being a difference between a true resistance value and an estimated resistance value of the voice coil motor, wherein
the identification structure can minimize an estimated error defined as a difference between an estimated value ŷ(k) of the head speed and the head speed y(k), and employs \hat{b}₁ to calibrate the estimated error;
\hat{b}₁ is determined by minimizing the estimated error; and
ŷ(k) and y(k) are defined by the equation (A):
ŷ(k)=−â₁y(k−1)+\hat{b}₀u(k−1)+\hat{b}₁u(k−2) (A),
y(k−1) denoting a head speed computed by the head-speed computing unit at the last sampling time k−1, k denoting the present sampling time, u(k−1) denoting an instruction current at the last sampling time k−1, u(k−2) denoting an instruction current at the last but one sampling time k−2, â₁, \hat{b}₀ denoting unknown variables to be determined by minimizing the estimated error.

2. The device according to claim 1, further comprising:
a targeted-speed generator to give a targeted speed to the head speed;
a speed-error generator to generate a speed error, the speed error being the difference between the head speed and the targeted speed, the head speed calibrated with \hat{b}₁ included in the equation (A); and
a feedback controller to compute the instruction current from the speed error.

3. The device according to claim 2, further comprising:
two feedback controllers, one of the controllers having a low gain, the other of the controllers having a high gain; or
one feedback controller having high and low gains.

4. The device according to claim 3, further comprising:
a means to determine whether or not the estimated error has been minimized, wherein
the instruction current is computed by giving a signal of the speed-error to the feedback controller having the low gain when the means determines that the estimated error has not yet been minimized; and
the instruction current is computed by giving a signal of the speed-error to the feedback controller having the high gain when the means determines that the estimated error has been minimized.

5. The device according to claim 4, wherein
a dummy white noise or a random signal is given to the targeted speed when the means determines that the estimated error has not yet been minimized; and
a head speed necessary for a ramp-unloading seek is given to the targeted speed when the means determines that the estimated error has been minimized.

6. The device according to claim 2, wherein
an estimated error \hat{θ}(k) is computed from the equation (C) and employed for a calibration gain to calibrate an error arising from a variation in coil resistance of the voice coil motor, the estimated error \hat{θ}(k) being a difference between a true value of the coil resistance and an estimated value of the coil resistance, the equation (C) including a model output zₘ(k) at the present time k, the instruction current u(k−1), and the instruction current u(k−2), the model output zₘ(k) being computed by inputting a targeted speed r(k) into a model Gₘ(z), the model Gₘ(z) being expressed by the equation (B), the equation (B) including a transfer characteristic Pₙ(z) and another transfer characteristic C(z), the transfer characteristic Pₙ(z) transferring an instruction current to a head speed when the variation is zero, the feedback controller having the transfer characteristic C(z), z of the equation (B) denoting a delay operator, the equation (B) being defined as
$${G}_{m} ( z ) = \frac{{z}^{- 1} C ( z )}{1 + {P}_{n} ( z ) C ( z )} , \qquad ( B )$$
the equation (C) being defined as
\hat{θ}(k)=\hat{θ}(k−1)−Γu(k−2)(u(k−1)−zₘ(k)) (C).
